(19) United States
(12) Patent Application Publication
(10) Pub. No.: US 2026/0270567 A1
(43) Pub. Date: Sep. 10, 2026

(54) APPARATUS AND METHOD FOR PROCESSING IMAGE

(71) Applicant: HANWHA VISION CO., LTD., Seongnam-si (KR)

(72) Inventors: Seung Won PARK, Deongnam-si (KR); Dae Bong Kim, Seongnam-si (KR)

(73) Assignee: HANWHA VISION CO., LTD., Seongnam-si (KR)

(21) Appl. No.: 19/662,076

(22) Filed: Apr. 29, 2026

Related U.S. Application Data
(63) Continuation of application No. PCT/KR2024/096235, filed on Oct. 7, 2024.

(30) Foreign Application Priority Data
Nov. 14, 2023 (KR) 10-2023-0156916

(51) Int. Cl. H04N 23/76; H04N 19/176; H04N 23/72

(52) U.S. Cl. CPC H04N 23/76; H04N 19/176; H04N 23/72

(57) ABSTRACT

An image processing apparatus includes: an imaging device configured to generate an original image of a subject by capturing an image of the subject; an image processor configured to generate a modified image by modifying brightness of the original image; and an image compressor configured to compress the modified image based on imaging information used to generate the original image and modification information used to generate the modified image.

### CROSS-REFERENCE TO RELATED APPLICATIONS

This application is a bypass continuation application of International Application No. PCT/KR2024/096235, filed on Oct. 7, 2024, in the Korean Intellectual Property Receiving Office, which is based on and claims priority to Korean Patent Application No. 10-2023-0156916, filed on Nov. 14, 2023, in the Korean Intellectual Property Office, the disclosures of which are incorporated by reference herein in their entireties.

### BACKGROUND

The present disclosure relates to an image processing apparatus and method, and more particularly, to an image processing apparatus and method for compressing an image with reference to a brightness component included in the image and noise processing information of the image.

Since the amount of raw data generated by an image sensor is very large, it may not be easy to process such raw data. For example, a large amount of network resources may be consumed in order to transmit an image composed only of raw data over a long distance.

For ease of image processing, the raw data may be compressed. Because an image generated by compressing the raw data has a relatively small size, transmission and playback through a network may be easily performed.

The raw data may be compressed after image processing is performed. When image processing is performed on raw data generated in a relatively low-illumination environment, a resulting image may include a large amount of noise components. Noise components included in the image may act as a factor that degrades the compression ratio.

Accordingly, there is a need for the development of a technology capable of compressing an image including noise at a high compression ratio.

### SUMMARY

An object of the present disclosure is to provide an image processing apparatus and method for compressing an image based on a brightness component included in the image and noise processing information of the image.

The objects of the present disclosure are not limited to the above-mentioned object, and other objects not mentioned herein will be clearly understood by those skilled in the art from the following description.

According to an aspect of the present disclosure, there is provided an image processing apparatus which may include: an imaging device configured to generate an original image of a subject by capturing an image of the subject; an image processor configured to generate a modified image by modifying brightness of the original image; and an image compressor configured to compress the modified image based on imaging information used to generate the original image and modification information used to generate the modified image.

The imaging information may include information regarding an illumination environment of an image capturing site in which the image is captured.

The imaging information may include at least one of an aperture value and a shutter speed.

The modification information may include information for improving the brightness of the original image.

The modification information may include at least one of gain, a noise reduction level, and a sharpness level.

The image compressor may be configured to compress the modified image using a quantization parameter determined based on the imaging information and the modification information.

The quantization parameter may include: a global quantization parameter applied to an entire area of the modified image; and a local quantization parameter applied to a partial area of the modified image.

The image compressor may be configured selectively to: compress the modified image using only the global quantization parameter; compress the modified image using only the local quantization parameter; or compress the modified image using the global quantization parameter and the local quantization parameter.

The image compressor may be configured to: based on brightness of the partial area being lower than an average brightness of the entire area, compress the partial area using a local quantization parameter having a higher value than the global quantization parameter; and based on the brightness of the partial area being higher than the average brightness of the entire area, compress the partial area using a local quantization parameter having a lower value than the global quantization parameter.

The quantization parameter may include a local quantization parameter applied to a partial area of the modified image, and the image compressor may be configured to compress the partial area using a local quantization parameter having a higher value as brightness of the local area decreases.

The image processor may be configured to divide the original image into a plurality of blocks and generate modified blocks by modifying brightness for each of the divided blocks, and the image compressor may be configured to generate compressed blocks by performing compression on each of the modified blocks.

According to an aspect of the present disclosure, there is provided an image processing method which may include: generating an original image of a subject by capturing an image of the subject; generating a modified image by modifying brightness of the original image; and compressing the modified image based on imaging information used to generate the original image and modification information used to generate the modified image.

The imaging information may include information regarding an illumination environment of an image capturing site in which the image is captured and the imaging information comprises at least one of an aperture value and a shutter speed.

The modification information may include information for improving the brightness of the original image, and the modification information may include at least one of gain, a noise reduction level, and a sharpness level.

The compressing the modified image may include compressing the modified image using a quantization parameter determined based on the imaging information and the modification information.

The quantization parameter may include: a global quantization parameter applied to an entire area of the modified image; and a local quantization parameter applied to a partial area of the modified image.

The compressing the modified image may include selectively: compressing the modified image using only the global quantization parameter; compressing the modified image using only the local quantization parameter; or compressing the modified image using the global quantization parameter and the local quantization parameter.

The compressing the modified image may include: based on brightness of the partial area being lower than an average brightness of the entire area, compressing the partial area using a local quantization parameter having a higher value than the global quantization parameter; and based on the brightness of the partial area being higher than the average brightness of the entire area, compressing the partial area using a local quantization parameter having a lower value than the global quantization parameter.

The quantization parameter may include a local quantization parameter applied to a partial area of the modified image, and the compressing the modified image may include compressing the partial area using a local quantization parameter having a higher value as brightness of the partial area decreases.

The generating the modified image may include dividing the original image into a plurality of blocks and generating modified blocks by modifying brightness for each of the divided blocks, and the compressing the modified image may include generating compressed blocks by performing compression for each of the modified blocks.

Specific details of other embodiments are included in the detailed description and the drawings.

According to the image processing apparatus and method of the present disclosure as described above, since an image is compressed with reference to a brightness component included in the image and noise processing information of the image, there is an advantage of improving the compression ratio of the image.

The effects of the present disclosure are not limited to the above-mentioned effects, and other effects not mentioned herein will be clearly understood by those skilled in the art from the description of the claims.

### BRIEF DESCRIPTION OF DRAWINGS

FIG. 1 is a block diagram of an image processing apparatus according to an embodiment of the present disclosure.

FIG. 2 is a block diagram of an imaging device illustrated in FIG. 1.

FIG. 3 is a view illustrating an original image.

FIG. 4 is a view for explaining an operation of an image compressor.

FIG. 5 is a view illustrating a quantization parameter table.

FIG. 6 is a view for explaining compression of a modified image using a global quantization parameter.

FIG. 7 is a view for explaining compression of a modified image using a local quantization parameter.

FIG. 8 is a view for explaining compression of a modified image using a global quantization parameter and a local quantization parameter.

FIG. 9 is a view illustrating modified images having different brightness distributions.

FIG. 10 is a flowchart illustrating an image processing method according to an embodiment of the present disclosure.

### DETAILED DESCRIPTION

Hereinafter, example embodiments of the present disclosure will be described in detail with reference to the accompanying drawings. The advantages and features of the present disclosure and methods for achieving the same will become apparent from the embodiments described below in detail together with the accompanying drawings. However, the present disclosure is not limited to the embodiments disclosed below and may be implemented in various different forms. These embodiments are provided only to make the disclosure of the present disclosure complete and to fully inform one of ordinary skill in the art of the scope of the invention, and the present disclosure is defined only by the scope of the claims. Throughout the specification, like reference numerals refer to like elements.

Unless otherwise defined, all terms used herein, including technical and scientific terms, may have meanings commonly understood by one of ordinary skill in the art to which the present disclosure pertains. In addition, terms defined in commonly used dictionaries should not be interpreted ideally or excessively unless clearly and specifically defined. As used herein, expressions “at least one of a, b, and c” and “at least one of a, b, or c” should be understood as including only a, only b, only c, both a and b, both a and c, both b and c, or all of a, b, and c

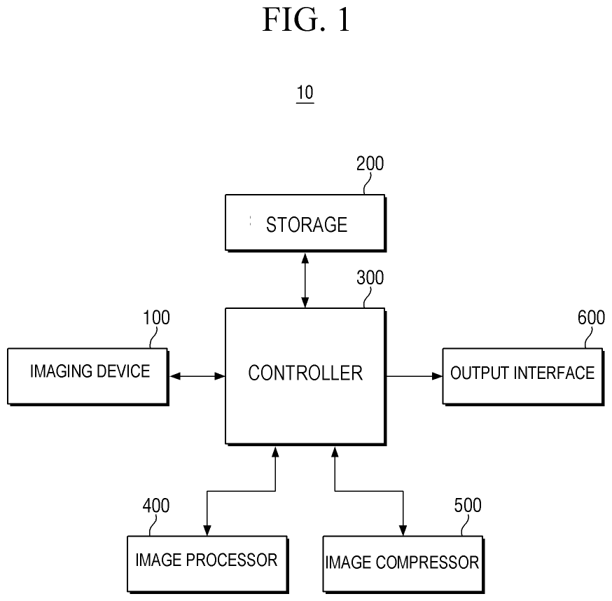

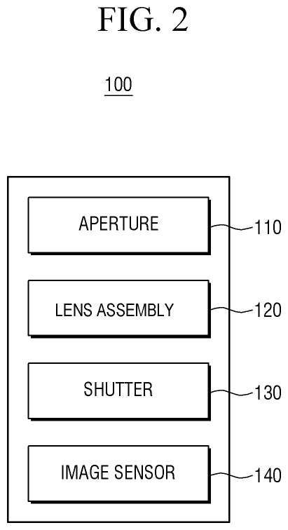

FIG. 1 is a block diagram of an image processing apparatus according to an embodiment of the present disclosure, and FIG. 2 is a block diagram of an imaging device illustrated in FIG. 1.

Referring to FIG. 1, an image processing apparatus 10 according to an embodiment of the present disclosure includes an imaging device 100, a storage 200, a controller 300, an image processor 400, an image compressor 500, and an output interface 600.

The imaging device 100, which may be or include a camera or a surveillance camera, may capture an image of a subject and generate an original image of the subject. For this purpose, as illustrated in FIG. 2, the imaging device 100 may include an aperture 110, a lens assembly 120, a shutter 130, and an image sensor 140. In the present disclosure, the original image generated by the imaging device 100 may be a moving image or a still image.

The aperture 110 may adjust an amount of light incident on the imaging device 100. The aperture 110 may include an aperture hole through which light passes. The amount of light incident on the imaging device 100 may be determined according to a size of the aperture hole. The size of the aperture hole may be determined by an aperture value described later.

The a lens assembly 120 may receive light from the subject. Specifically, the a lens assembly 120 may receive light that has passed through the aperture hole of the aperture 110. The a lens assembly 120 may include one or more lenses. A plurality of lenses may be arranged in parallel along an optical axis of the lens assembly 120 and may sequentially transmit light. The lens assembly 120 may include various lenses for concentrating light, sharpening boundaries of the subject, enhancing color, reducing distortion of the subject, or magnifying the subject. In addition, the lens assembly 120 may include a focus. The focus lens may move in a direction parallel to the optical axis of the lens assembly 120. A focal distance to the subject may be changed according to a position of the focus lens.

The shutter 130 may block or allow light incident on the image sensor 140. Light that has passed through the lens assembly 120 may be incident on the image sensor 140 through the shutter 130. The shutter 130 may include a shutter hole through which light passes. The shutter hole may be opened only for a predetermined time, and during that time, light may be incident on the image sensor 140. An opening time of the shutter hole may be determined by a shutter speed described later.

The image sensor 140 may generate an original image using light incident through the lens assembly 120. For example, a charge-coupled device (CCD) or a complementary metal-oxide semiconductor (CMOS) sensor may serve as the image sensor 140.

The imaging device 100 may further include a direction switch for changing an imaging direction. The direction switch may change the imaging direction of the imaging device 100 by rotating the imaging device 100 in a pan direction or a tilt direction. The direction switch may change the imaging direction of the imaging device 100 according to a preset control command or a user command.

Referring again to FIG. 1, the storage 200, which may be or include one or more memory devices, may temporarily or permanently store an original image generated by the imaging device 100. In addition, the storage 200 may store a modified image generated by the image processor 400 and a compressed image generated by the image compressor 500. The storage 200 may also store a quantization parameter table described later.

The image processor 400 may modify the brightness of the original image to generate a modified image. An environment in which the imaging device 100 generates the original image may be an environment (hereinafter referred to as a low-illumination environment) having relatively low ambient light, such as nighttime. Since an original image generated in such a low-illumination environment may not be clearly recognized by a user, an increase in overall brightness may be required. The image processor 400 may modify the overall brightness of the original image to generate the modified image.

The image compressor 500 may compress the modified image to generate a compressed image. Because the modified image has a relatively large amount of data, excessive resources may be required for transmission and computation through a network. Since the compressed image generated by the image compressor 500 has a small data amount, transmission and computation through a network may be easily performed.

Meanwhile, the modified image may include noise. In particular, when the original image generated in the low-illumination environment is modified by the image processor 400, a large amount of noise may be included in the modified image. This is because noise is also increased during the process of increasing the brightness of the original image generated in the low-illumination environment.

When noise is included in the modified image, compression efficiency by the image compressor 500 may decrease. In order to improve compression efficiency, the image compressor 500 may compress the modified image with reference to imaging information used to generate the original image and modification information used to generate the modified image. The imaging information and the modification information may include information regarding a brightness component of the original image. For example, the imaging information may include information regarding an illumination environment of a shooting site or an image capturing site in which the original image is captured or generated, and the modification information may include information for improving the brightness of the original image.

The imaging information may include at least one of an aperture value and a shutter speed, and the modification information may include at least one of gain, a noise reduction level, and a sharpness level. When an illumination environment of the shooting site or the image capturing site in which the original image is captured or generated is a low-illumination environment, the imaging device 100 may decrease the aperture value and the shutter speed to allow more light to be incident thereon. As the aperture value decreases, a diameter of the aperture hole may increase, and as the shutter speed decreases, a time during which the image sensor 140 is exposed to light may increase. For example, when the aperture value and the shutter speed decrease, an amount of light incident on the image sensor 140 increases.

Despite adjustment of the aperture value and the shutter speed, the original image generated in the low-illumination environment may not be easily recognized by a user. The image processor 400 may modify the brightness of the original image so as to be easily recognizable by the user. In this case, the image processor 400 may adjust the gain, the noise reduction level, and the sharpness level. That is, the image processor 400 may increase the gain of the original image. As the gain increases, the overall brightness of the original image may increase. Meanwhile, when the gain increases, noise may also increase. Accordingly, the image processor 400 may increase the noise reduction level to reduce noise. In addition, when there is much noise in the original image, sharpness may increase. Accordingly, the image processor 400 may decrease the sharpness level to reduce sharpness. The modification information may be obtained by such an operation of the image processor 400.

As described above, the imaging information and the modification information may be obtained by reflecting brightness information of the original image, and the image compressor 500 may generate a compressed image with reference to the brightness information of the original image. For example, when the original image is generated in a low-illumination environment, the image compressor 500 may increase a compression ratio, and when the original image is generated in a high-illumination environment, the image compressor 500 may decrease the compression ratio. Through this, a data amount of the compressed image generated by the image compressor 500 may be uniformly controlled. In addition, the imaging information and the modification information may be obtained at time points when the original image and the modified image are respectively generated. For example, in order to obtain brightness information included in the modified image, the image compressor 500 does not need to perform a separate operation, and the image compressor 500 may perform fast compression using the imaging information and the modification information, which are obtainable before generating the compressed image.

The output interface 600 may output the compressed image generated by the image compressor 500. For example, the output interface 600 may visually display the compressed image. In addition, according to some embodiments of the present disclosure, the output interface 600 may have a communication function and may transmit the compressed image. The user may receive and check the image transmitted by the output interface 600 through the user's terminal.

The controller 300 may perform overall control of the imaging device 100, the storage 200, the image processor 400, the image 500, and the output interface 600. For example, the aperture value and the shutter speed of the imaging device 100 may be obtained by the controller 300 and transmitted to the imaging device 100.

Each of the components illustrated in FIGS. 1 and 2 may refer to software or hardware such as a field-programmable gate array (FPGA) or an application-specific integrated circuit (ASIC). However, the corresponding components are not limited to software or hardware, may be configured to be in a storage medium that can be addressed, or may be configured to be executed by one or more processors. Functions provided by such components may be implemented by more subdivided components, and a plurality of components may be combined and implemented as one component that performs a specific function.

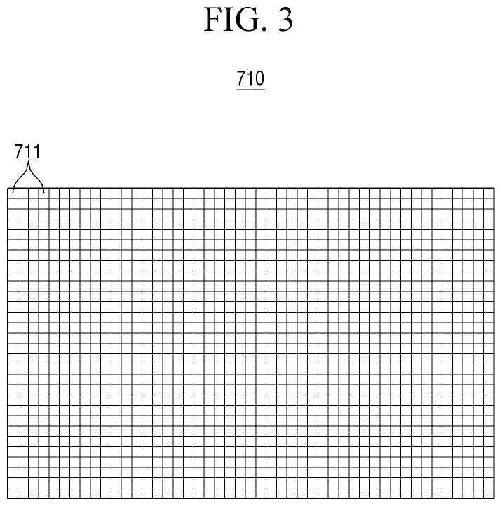

FIG. 3 is a view illustrating an original image.

Referring to FIG. 3 along with FIG. 1, the image processor 400 may divide an original image 710 into a plurality of blocks 711 and may modify brightness for each of the divided blocks 711.

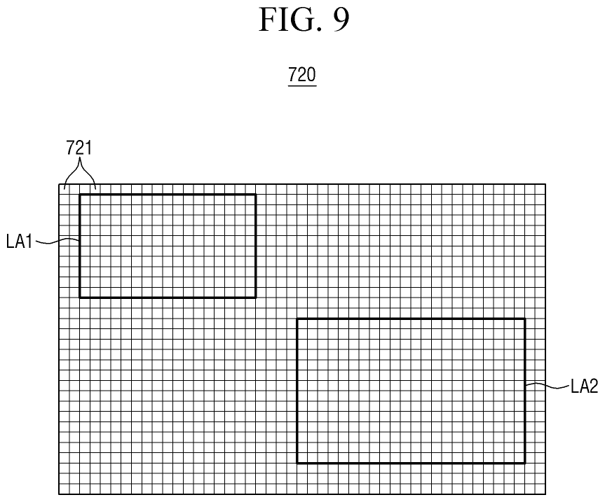

The image processor 400 may determine gain, a noise reduction level, and a sharpness level for each of the divided blocks 711, and may modify brightness of each of the divided blocks 711 based thereon. Hereinafter, blocks generated by modifying the divided blocks 711 by the image processor 400 will be referred to as modified blocks 721 (see FIG. 9). For example, an image modification unit included in the image processor 400 may perform modification on a first divided block to generate a first modified block, and may perform modification on a second divided block to generate a second modified block. A modified image may be formed by combining all modified blocks. In the present disclosure, a size of each of the divided blocks 711 may be 8×8, but is not limited thereto.

The image compressor 500 may perform compression for each of the modified blocks 721. Hereinafter, the modified blocks 721 compressed by the image compressor 500 will be referred to as compressed blocks. For example, the image compressor 500 may perform compression on the first modified block to generate a first compressed block and may perform compression on the second modified block to generate a second compressed block. A compressed image may be formed by combining all compressed blocks.

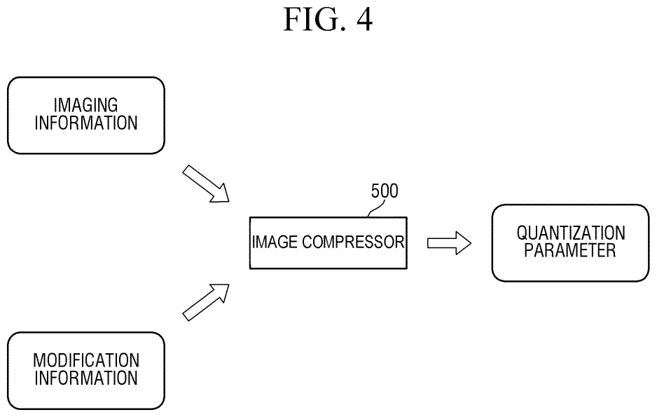

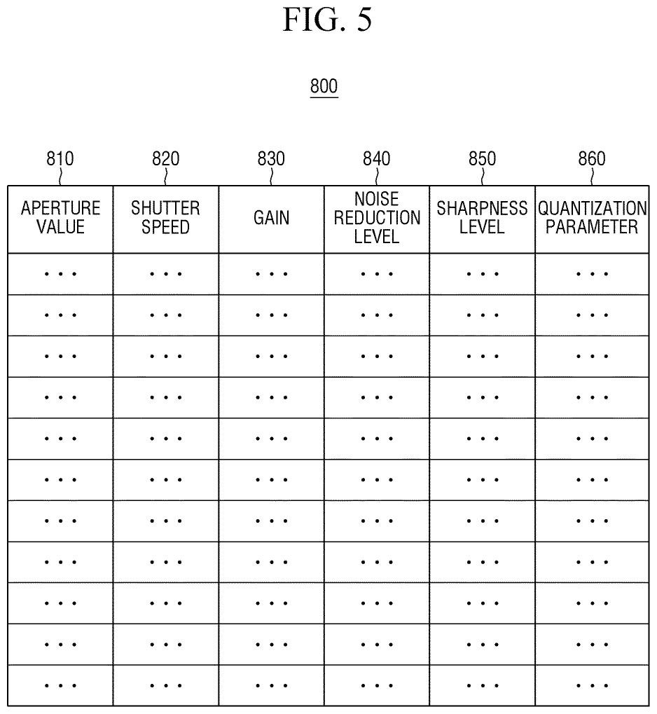

FIG. 4 is a view for explaining an operation of an image compressor, and FIG. 5 is a view illustrating a quantization parameter table.

Referring to FIG. 4 along with FIG. 1, the image compressor 500 may compress the modified image using a quantization parameter QP determined in correspondence with the imaging information and the modification information.

As the quantization parameter increases, the image quality may decrease and the compression ratio may increase. As the quantization parameter decreases, the image quality may increase and the compression ratio may decrease. When the original image 710 is generated in a low-illumination environment, the image compressor 500 may increase the compression ratio by applying a relatively high quantization parameter, and when the original image 710 is generated in a high-illumination environment, the image compressor 500 may decrease the compression ratio by applying a relatively low quantization parameter.

The original image 710 generated in the low-illumination environment may include much noise. When the compression ratio increases, noise may decrease and an increase in the data amount of the compressed image may be prevented. The original image 710 generated in the high-illumination environment may include little noise. When the compression ratio decreases, the image quality may increase. In addition, since compression is performed on the modified image having little noise, the compressed image may be formed to have a relatively small data amount.

The quantization parameter may be provided in the form of a table (a quantization parameter table). The image compressor 500 may extract the quantization parameter with reference to a quantization parameter table 800.

Referring to FIG. 5, the quantization parameter table 800 may include an aperture value field 810, a shutter speed field 820, a gain field 830, a noise reduction level field 840, a sharpness level field 850, and a quantization parameter field 860.

In the aperture value field 810, an aperture value that determines a diameter of an aperture hole may be specified. In the shutter speed field 820, a shutter speed that determines a speed of opening and closing of the shutter 130 may be specified. In the gain field 830, gain for adjusting brightness of the original image 710 may be specified. In the noise reduction level field 840, a noise reduction level indicating a degree of reducing noise included in the original image 710 may be specified. In the sharpness level field 850, a sharpness level for adjusting sharpness reflected in the original image 710 may be specified. In the quantization parameter field 860, a quantization parameter that determines the compression ratio may be specified.

The image compressor 500 may apply the aperture value, the shutter speed, the gain, the noise reduction level, and the sharpness level received from the imaging device 100 and the image processor 400 to the quantization parameter table 800 to extract a corresponding quantization parameter. Then, the image compressor 500 may apply the quantization parameter to the modified image to generate the compressed image.

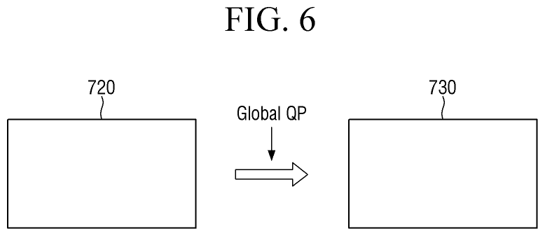

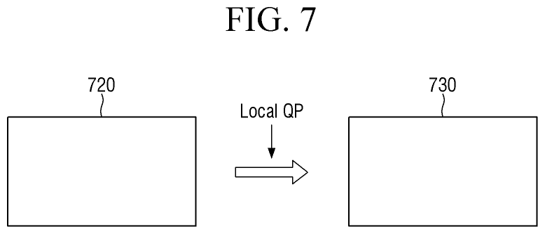

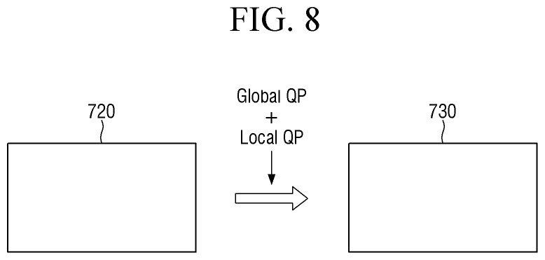

FIG. 6 is a view for explaining compression of a modified image using a global quantization parameter, FIG. 7 is a view for explaining compression of a modified image using a local quantization parameter, FIG. 8 is a view for explaining compression of a modified image using a global quantization parameter and a local quantization parameter, and FIG. 9 is a view illustrating modified images having different brightness distributions.

In the present disclosure, the quantization parameter may include a global quantization parameter and a local quantization parameter. The global quantization parameter indicates a quantization parameter applied to an entire area (hereinafter referred to as a global area) of a modified image 720, and the local quantization parameter indicates a quantization parameter applied to a partial area (hereinafter referred to as a local area) of the modified image 720.

Referring to FIGS. 6 to 8, the image compressor 500 may compress the modified image 720 using only the global quantization parameter, may compress the modified image 720 using only the local quantization parameter, or may compress the modified image 720 using the global quantization parameter and the local quantization parameter.

When only the global quantization parameter is used, the image compressor 500 may generate a compressed image 730 by applying the same global quantization parameter to all modified blocks 721 included in the modified image 720. The image compressor 500 may extract one quantization parameter using representative values of the gain, the noise reduction level, and the sharpness level determined for all modified blocks 721, and may perform compression on all modified blocks 721 using the quantization parameter. Here, the representative values may be average values or median values. For example, the representative value of the gain may be an average value or a median value of a sum of gains of all modified blocks 721.

When only the local quantization parameter is used, the image compressor 500 may generate the compressed image 730 by applying the local quantization parameter for each of the modified blocks 721 included in the modified image 720. The image compressor 500 may extract a quantization parameter for a corresponding modified block 721 using representative values of the gain, the noise reduction level, and the sharpness level determined for the corresponding modified block 721, and may perform compression on the corresponding modified block 721 using the extracted quantization parameter.

When the global quantization parameter and the local quantization parameter are both used, the image compressor 500 may apply the global quantization parameter to the global area, which is the entire area of the modified image 720, and may apply the local quantization parameter to the local area, which is a partial area of the modified image 720. Here, the global quantization parameter may be extracted using representative values of the gain, the noise reduction level, and the sharpness level determined for all modified blocks 721.

The local area may be a set of a plurality of modified blocks 721 having similar brightness. For example, when modified blocks 721 having brightness within a preset range are grouped and disposed adjacent to each other, the corresponding group may be the local area.

Referring to FIG. 9, the modified image 720 may include at least one local area. The image compressor 500 may compress the global area using the global quantization parameter and may compress the local area using the local quantization parameter.

The image compressor 500 may perform compression for each local area. The image compressor 500 may extract a quantization parameter using representative values of the gain, the noise reduction level, and the sharpness level determined for modified blocks 721 included in the local area, and may perform compression on the local area using the quantization parameter.

When brightness of the local area is lower than an average brightness of the global area, the image compressor 500 may compress the local area using a local quantization parameter having a higher value than the global quantization parameter, and when brightness of the local area is higher than the average brightness of the global area, the image compressor 500 may compress the local area using a local quantization parameter having a lower value than the global quantization parameter.

FIG. 9 illustrates a modified image 720 including a first local area LA1 having a brightness lower than an average brightness of all modified blocks 721 and a second local area LA2 having a brightness higher than the average brightness of all modified blocks 721. The image compressor 500 may extract, for the first local area LA1, a local quantization parameter having a higher value than the global quantization parameter, and may extract, for the second local area LA2, a local quantization parameter having a lower value than the global quantization parameter. Accordingly, the first local area LA1 may be compressed at a high compression ratio, and the second local area LA2 may be compressed at a low compression ratio.

The first local area LA1 may include a relatively large amount of noise. As the first local area LA1 is compressed at the high compression ratio, noise included in the first local area LA1 is suppressed, and an increase in the amount of compressed data generated for the first local area LA1 may be prevented.

The second local area LA2 may include a relatively small amount of noise and may include an object that is easily visually recognizable. As the second local area LA2 is compressed at the low compression ratio, an image quality of the second local area LA2 may increase.

In addition, the image compressor 500 may compress a local area using a local quantization parameter having a higher value as brightness of the local area decreases. For example, the image compressor 500 may compress a local area by considering only brightness of the local area regardless of the average brightness of the global area. A local area having relatively low brightness and including a large amount of noise may be compressed at a relatively high compression ratio. Accordingly, noise included in the local area is suppressed, and an increase in the amount of compressed data generated for the local area may be prevented.

A local area having relatively a high brightness and including a small amount of noise may be compressed at a relatively low compression ratio. Accordingly, image quality of the local area may increase.

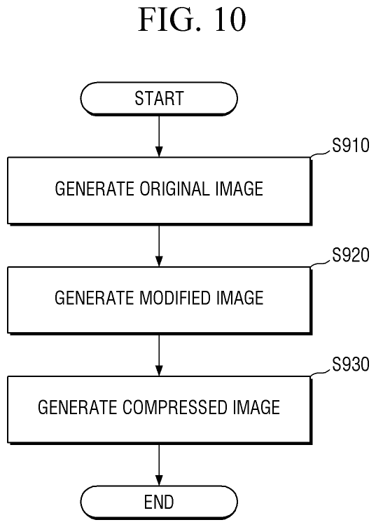

FIG. 10 is a flowchart illustrating an image processing method according to an embodiment of the present disclosure.

Referring to FIG. 10 along with FIG. 1, in the image processing apparatus 10 according to an embodiment of the present disclosure, the imaging device 100 may generate an original image 710 of a subject (S910) by capturing an image of the subject; the image processor 400 may generate a modified image 720 (S920) by modifying brightness of the original image 710; and the image compressor 500 may generate a compressed image 730 (S930) by compressing the modified image 720 with reference to imaging information used to generate the original image 710 and modification information used to generate the modified image 720.

The imaging device 100 may generate the original image 710 by adjusting at least one of the aperture value and the shutter speed according to an illumination environment at a time point at which an image of the subject is captured. The image processor 400 may generate the modified image 720 by adjusting at least one of the gain, the noise reduction level, and the sharpness level of the original image 710. In this case, the image processor 400 may divide the original image 710 into a plurality of blocks 711 and may perform brightness adjustment, noise adjustment, and sharpness adjustment for each of the divided blocks 711. The image compressor 500 may extract a quantization parameter with reference to the aperture value, the shutter speed, the gain, the noise reduction level, and the sharpness level, and may compress the modified image 720 based on the extracted quantization parameter. In the present disclosure, the quantization parameter may include a global quantization parameter and a local quantization parameter. The image compressor 500 may compress the modified image 720 using only the global quantization parameter, may compress the modified image 720 using only the local quantization parameter, or may compress the modified image 720 using the global quantization parameter and the local quantization parameter.

Although embodiments of the present disclosure have been described above with reference to the accompanying drawings, one of ordinary skill in the art to which the present disclosure pertains will understand that the present disclosure may be implemented in other specific forms without changing the technical spirit or essential features thereof. Therefore, it should be understood that the embodiments described above are illustrative in all respects and not restrictive.

What is claimed is:

1. An image processing apparatus comprising:
an imaging device configured to generate an original image of a subject by capturing an image of the subject;
an image processor configured to generate a modified image by modifying brightness of the original image; and
an image compressor configured to compress the modified image based on imaging information used to generate the original image and modification information used to generate the modified image.

2. The image processing apparatus of claim 1, wherein the imaging information comprises information regarding an illumination environment of an image capturing site in which the image is captured.

3. The image processing apparatus of claim 2, wherein the imaging information comprises at least one of an aperture value and a shutter speed.

4. The image processing apparatus of claim 1, wherein the modification information comprises information for improving the brightness of the original image.

5. The image processing apparatus of claim 4, wherein the modification information comprises at least one of gain, a noise reduction level, and a sharpness level.

6. The image processing apparatus of claim 1, wherein the image compressor is configured to compress the modified image using a quantization parameter determined based on the imaging information and the modification information.

7. The image processing apparatus of claim 6, wherein the quantization parameter comprises:
a global quantization parameter applied to an entire area of the modified image; and
a local quantization parameter applied to a partial area of the modified image.

8. The image processing apparatus of claim 7, wherein the image compressor is configured selectively to:
compress the modified image using only the global quantization parameter;
compress the modified image using only the local quantization parameter; or
compress the modified image using the global quantization parameter and the local quantization parameter.

9. The image processing apparatus of claim 7, wherein the image compressor is configured to:
based on brightness of the partial area being lower than an average brightness of the entire area, compress the partial area using a local quantization parameter having a higher value than the global quantization parameter; and
based on the brightness of the partial area being higher than the average brightness of the entire area, compress the partial area using a local quantization parameter having a lower value than the global quantization parameter.

10. The image processing apparatus of claim 6, wherein:
the quantization parameter comprises a local quantization parameter applied to a partial area of the modified image; and
the image compressor is configured to compress the partial area using a local quantization parameter having a higher value as brightness of the local area decreases.

11. The image processing apparatus of claim 1, wherein:
the image processor is configured to divide the original image into a plurality of blocks and generate modified blocks by modifying brightness for each of the divided blocks; and
the image compressor is configured to generate compressed blocks by performing compression on each of the modified blocks.

12. An image processing method comprising:
generating an original image of a subject by capturing an image of the subject;
generating a modified image by modifying brightness of the original image; and
compressing the modified image based on imaging information used to generate the original image and modification information used to generate the modified image.

13. The image processing method of claim 12, wherein:
the imaging information comprises information regarding an illumination environment of an image capturing site in which the image is captured and
the imaging information comprises at least one of an aperture value and a shutter speed.

14. The image processing method of claim 12, wherein:
the modification information comprises information for improving the brightness of the original image; and
the modification information comprises at least one of gain, a noise reduction level, and a sharpness level.

15. The image processing method of claim 12, wherein the compressing the modified image comprises compressing the modified image using a quantization parameter determined based on the imaging information and the modification information.

16. The image processing method of claim 15, wherein the quantization parameter comprises:
a global quantization parameter applied to an entire area of the modified image; and
a local quantization parameter applied to a partial area of the modified image.

17. The image processing method of claim 16, wherein the compressing the modified image comprises selectively:
compressing the modified image using only the global quantization parameter;
compressing the modified image using only the local quantization parameter; or
compressing the modified image using the global quantization parameter and the local quantization parameter.

18. The image processing method of claim 17, wherein the compressing the modified image comprises:
based on brightness of the partial area being lower than an average brightness of the entire area, compressing the partial area using a local quantization parameter having a higher value than the global quantization parameter; and
based on the brightness of the partial area being higher than the average brightness of the entire area, compressing the partial area using a local quantization parameter having a lower value than the global quantization parameter.

19. The image processing method of claim 15, wherein:
the quantization parameter comprises a local quantization parameter applied to a partial area of the modified image; and
the compressing the modified image comprises compressing the partial area using a local quantization parameter having a higher value as brightness of the partial area decreases.

20. The image processing method of claim 12, wherein:
the generating the modified image comprises dividing the original image into a plurality of blocks and generating modified blocks by modifying brightness for each of the divided blocks; and
the compressing the modified image comprises generating compressed blocks by performing compression for each of the modified blocks.
